(19) United States
(12) Patent Application Publication
(10) Pub. No.: US 2025/0376051 A1
(43) Pub. Date: Dec. 11, 2025

(54) CONNECTOR PROTECTION SYSTEM OF AN ENERGY TRANSFER SYSTEM

(71) Applicant: Caterpillar Inc., Peoria, IL (US)

(72) Inventors: Matthew SHERWOOD, Christchurch (NZ); Elliot MOSS, Christchurch (NZ)

(73) Assignee: Caterpillar Inc., Peoria, IL (US)

(21) Appl. No.: 18/736,198

(22) Filed: Jun. 6, 2024

(51) Int. Cl. B60L 53/16; B60L 53/37

(52) U.S. Cl. CPC B60L 53/16; B60L 53/37; B60L 2200/40

(57) ABSTRACT

An energy transfer system comprises a robotic system and a connector protection system. The robotic system includes an end effector for enabling an energy transfer to a work machine via a receptacle access point of the work machine. The energy transfer is to occur when one or more plugs of the end effector are coupled to one or more receptacles included in the receptacle access point. The connector protection system is mounted on the end effector of the robotic system. The connector protection system is configured to protect the one or more plugs of the end effector when the one or more plugs are not coupled to the one or more receptacles. The connector protection system includes a connector protection mechanism for covering the one or more plugs and an adjustment system for removing and replacing the connector protection mechanism.

### TECHNICAL FIELD

The present disclosure relates generally to a connector protection system and, for example, to a connector protection system of an energy transfer system.

### BACKGROUND

Machines (e.g., that utilize an energy source other than fossil fuel, such as electricity, hydrogen, methanol, ammonia, or other sources of energy), such as vehicles or other mobile machines, that are at least partially powered by on-board energy storage systems (e.g., batteries, hydrogen fuel cells, chemical storage components, among other examples) can be environmentally-friendly alternatives to machines powered by fossil fuels. In many cases, such a machine includes an energy transfer interface that can be physically connected to an energy transfer system to allow an energy transfer from the energy transfer system to an on-board energy storage system of the machine (e.g., to replenish the on-board energy storage system). The energy transfer interface can include a connector, such as a receptacle, that is configured to couple to a corresponding connector, such as a plug, of the energy transfer system to enable the energy transfer.

Often, when the connector (e.g., the plug) of the energy transfer system is not in use (e.g., when not coupled to the corresponding connector of the energy transfer interface of the machine), the connector is exposed to environmental conditions (e.g., that include rain, snow, dirt, debris, among other examples) of a site where the energy transfer system is located. This can lead to physical degradation and damage of the connector and therefore impacts a capability of the connector to facilitate an energy transfer. This can result in a sub-optimal replenishment of an on-board energy storage system for a machine, such as in terms of an increased amount of time needed to replenish the energy for the machine and a decreased available energy level on-board the machine. Further, sub-optimal replenishment can impact operations of a machine, such as by reducing an amount of time that the machine is available to perform powered operations (e.g., as compared to an amount of time that the machine needs to be replenished with energy) and by reducing an amount of power that is available to perform the powered operations. Sub-optimal replenishment of the on-board energy storage system for the machine can, in some cases, also degrade the on-board energy storage system of the machine, which impacts a performance and/or an operable life of the on-board energy storage system, and of the machine.

German Patent Application No. DE102021130602A1 (the '602 application) discloses a charging device for automatically establishing an electrical contact between a connection device of the charging device and a contact unit of a motor vehicle. As described in the '602 application, a protective flap device comprises a coupling device which operatively connects a protective flap to a lifting device in such a way that movement of the latter can be transferred to the protective flap. Furthermore, the '602 application specifies that at least one protective flap is designed to close an extension opening when the connection device is in a stowed position, and to release the extension opening by moving the at least one protective flap from a first position into a second position. Additionally, the flaps are again in their second end position, while a plug is in its contact position. The '602 application further reveals that the flaps move apart essentially only horizontally and it is only when the plug has been extended to such an extent that it is already located above the flaps, that the flaps, also execute an increasing rotational movement, that is to say they tilt, and also move to the height together with the lifting device.

While the charging device described in the '602 application provides a charging device for automatically establishing an electrical contact, the charging device is complex. Such complexity introduces multiple points of failure, which can lead to device malfunctions and downtime. Any malfunction of the charging device (e.g., that causes the connection device of the charging device is “stuck” in an extended, unprotected position) can potentially cause contact damage to the connection device, the contact unit of the motor vehicle, and the motor vehicle itself. Further, per the '602 application, the charging device is intended to be located below the contact unit of the motor vehicle (e.g., as a ground unit), and therefore the charging devices is less adaptable to different vehicles types (e.g., work vehicles with a high ground clearance) and charging scenarios (e.g., where the contact unit of the motor vehicle is not located on an underside of the motor vehicle), and is susceptible to damage (e.g., by the motor vehicle, or another vehicle, running over the charging device when the charging device is on the ground).

The connector protection system of the present disclosure solves one or more of the problems set forth above and/or other problems in the art.

### SUMMARY

In some implementations, an energy transfer system comprises: a robotic system that includes an end effector for enabling an energy transfer to a work machine via a receptacle access point of the work machine, wherein the energy transfer is to occur when one or more plugs of the end effector are coupled to one or more receptacles included in the receptacle access point; and a connector protection system mounted on the end effector of the robotic system for protecting the one or more plugs of the end effector when the one or more plugs are not coupled to the one or more receptacles, wherein the connector protection system includes a connector protection mechanism for covering the one or more plugs.

In some implementations, an end effector of a robotic system includes a connector protection system for protecting one or more plugs of the end effector when not coupled to one or more receptacles included in a receptacle access point, wherein the connector protection system includes a connector protection mechanism for covering the one or more plugs, and wherein the connector protection system includes an adjustment system for removing and replacing the connector protection mechanism.

In some implementations, a connector protection system of an end effector of a robotic system includes a connector protection mechanism for covering one or more plugs of the end effector when the one or more plugs are not coupled to one or more receptacles included in a receptacle access point; and an adjustment system for removing and replacing the connector protection mechanism.

### BRIEF DESCRIPTION OF THE DRAWINGS

FIG. 1 is a diagram of an example work machine described herein.

FIGS. 2A-2B are diagrams of examples of a receptacle access point described herein.

FIGS. 3A-3B are diagrams of an example energy transfer system.

FIGS. 4A-4B are diagrams of examples of an end effector of a robotic system of the energy transfer system described herein.

FIGS. 5A-5E are diagrams of examples associated with a connector protection system of the energy transfer system described herein.

FIG. 6 is a diagram of example components of a device associated with a connector protection system of an energy transfer system.

FIG. 7 is a flowchart of an example process associated with a connector protection system of an energy transfer system.

### DETAILED DESCRIPTION

This disclosure relates to a connector protection system of an energy transfer system that is configured to enable an energy transfer to a work machine, which is applicable to any work machine that is at least partially powered by a non-fossil-fuel-based energy storage system. The work machine may be any type of machine configured to perform operations associated with an industry such as mining, construction, farming, transportation, or any other industry.

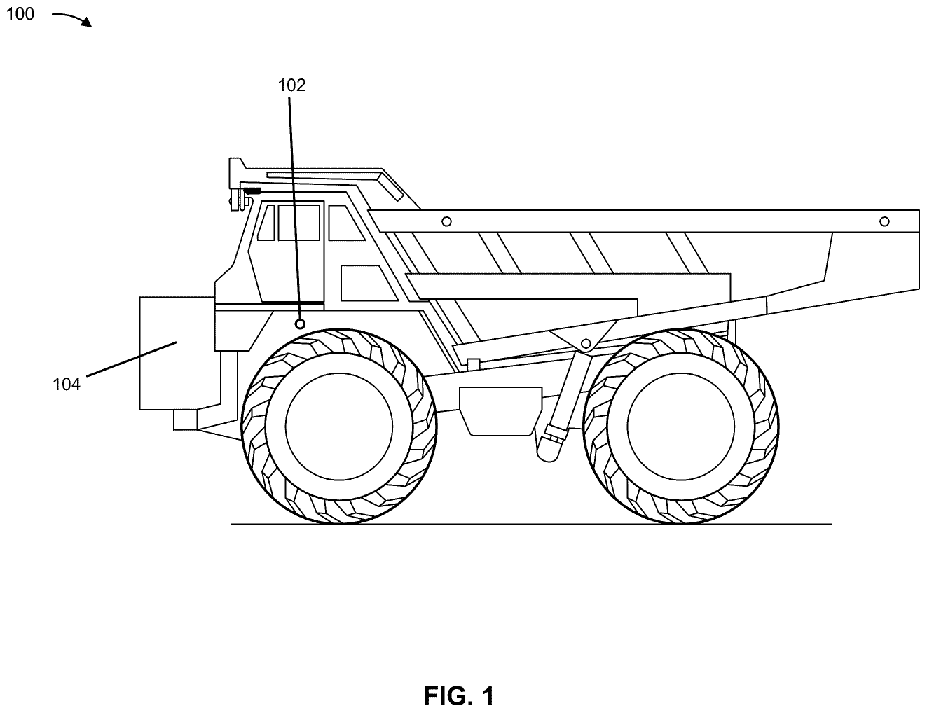

FIG. 1 is a diagram (e.g., a side-view) of an example work machine 100 described herein. The work machine 100 may be a mobile machine or vehicle, and may include a dump truck, a wheel loader, a hydraulic excavator, or another type of machine. Further, the work machine 100 may be a manned machine or an unmanned machine. The work machine 100 may be fully-autonomous, semi-autonomous, or remotely operated. As further shown in FIG. 1, the work machine 100 may include an energy storage system 102 (e.g., included within a chassis of the work machine 100) and a receptacle access point 104.

The work machine 100 may be configured to be at least partially powered by the energy storage system 102. That is, the work machine may be a machine that utilizes electricity, hydrogen, methanol, ammonia, or other sources of energy other than a fossil fuel. As a specific example, when the energy storage system 102 includes a battery that stores electricity, the work machine 100 may be a battery electric machine (BEM), a battery electric vehicle (BEV), a hybrid vehicle, a fuel cell and battery hybrid vehicle, or another machine that is at least partially powered by the battery of the energy storage system 102. The work machine 100 may include one or more engines, one or more motors, one or more conversion systems, and/or other components that are configured to convert and/or use energy stored in the energy storage system 102, to cause overall movement of the work machine 100 across a work site and/or to cause movement of individual components or systems of the work machine 100.

The receptacle access point 104 provides an energy transfer interface (e.g., a physical energy transfer interface) for the energy storage system 102. For example, the receptacle access point 104 provides an energy transfer interface that can be physically connected to an energy transfer system (e.g., the energy transfer system 300 described herein) to allow an energy transfer from the energy transfer system to the energy storage system 102 (or vice versa). The receptacle access point 104 may be located on a front of the work machine 100 (as shown), a side of the work machine 100, a back of the work machine 100, a bottom of the work machine 100, a top of the work machine 100, or at any other position on the work machine 100. The receptacle access point 104 is further described herein.

As indicated above, FIG. 1 is provided as an example. Other examples may differ from what is described in connection with FIG. 1.

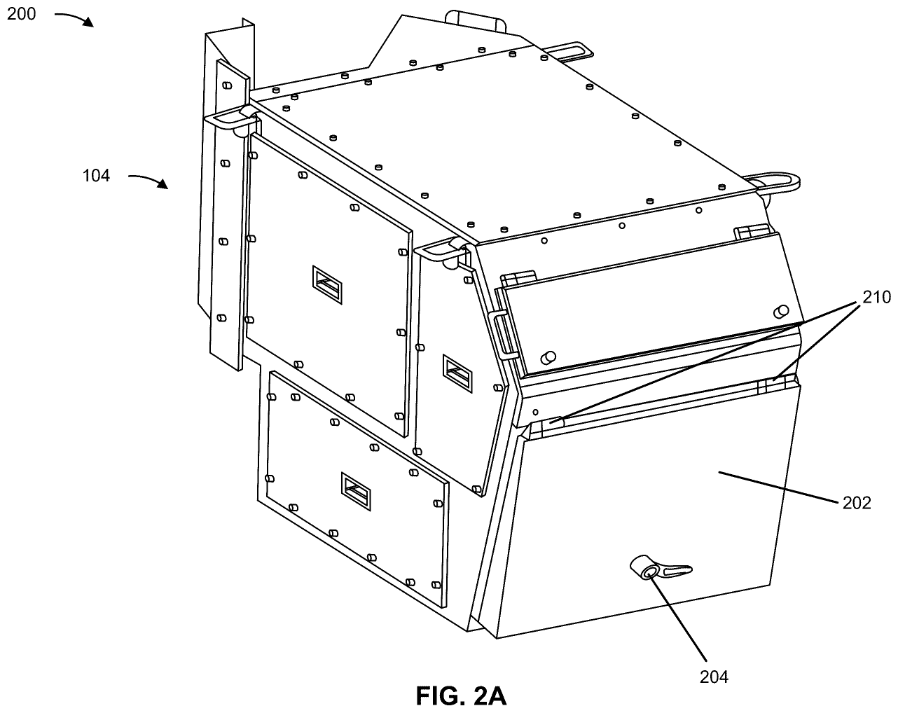

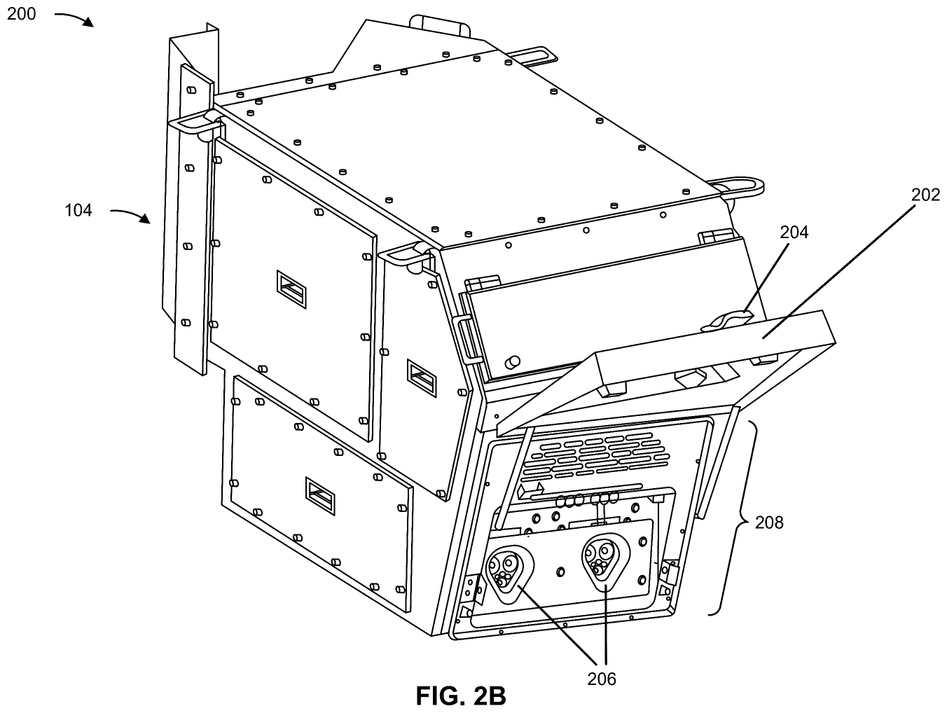

FIGS. 2A-2B are diagrams (e.g., front-angled views) of examples 200 of the receptacle access point 104 described herein. As shown in FIGS. 2A-2B, the receptacle access point 104 includes an access door 202, an access mechanism 204, and one or more receptacles 206. FIG. 2A shows the receptacle access point 104 in a closed state (e.g., when the access door 202 is in a closed position), and FIG. 2B shows the receptacle access point 104 in an open state (e.g., when the access door 202 is in an open position).

The access door 202 comprises a metal, or other hard and/or weather resistant material, and is configured to protect internal components of the receptacle access point 104, such as an interior panel 208 of the receptacle access point 104, when in the closed position. For example, when the access door 202 is in the closed position (e.g., such that edges of the access door 202 cover a flange of the interior panel 208) the access door 202 may prevent dirt, rocks, construction debris, waste matter, moisture, or other material (e.g., present at a work site at which the work machine 100 is operating) from accessing the interior panel 208. The access door 202 is moveable. For example, the access door 202 may be moved from the closed position (e.g., shown in FIG. 2A) to the open position (e.g., shown in FIG. 2B), such as by causing the access door 202 to pivot on one or more hinges 210.

The access mechanism 204 may be located on the access door 202, as shown in FIGS. 2A-2B, or may be located at any other position on the receptacle access point 104. The access mechanism 204 is configured to allow the access door 202 to open (e.g., to allow the access door 202 to move from the closed position to the open position and/or to remain at the open position) when the access mechanism 204 is disengaged. Further, the access mechanism 204 is configured to allow the access door 202 to remain closed (e.g., to remain in the closed position) when the access mechanism is engaged (e.g., after the access door 202 is moved to the closed position). That is, the access mechanism 204 may “lock” the access door 202 in the closed position when engaged, and may “unlock” the access door 202 to allow the access door 202 to move to the open position when disengaged.

The access mechanism 204 is configured to be manipulatable to cause the access mechanism 204 to be engaged (e.g., to change from disengaged to engaged) or to be disengaged (e.g., to change from engaged to disengaged). For example, the access mechanism 204 may be configured to be rotated, slid, pushed, pulled, lifted, extended, and/or retracted, among other examples, to cause the access mechanism 204 to be engaged or disengaged. Accordingly, the access mechanism 204 may include a latch, a bolt, a catch, a hook, a hasp, and/or a fastener, among other examples.

As shown in FIG. 2B, the one or more receptacles 206 may be included on the interior panel 208 of the receptacle access point 104. Each of the one or more receptacles 206 may be any type of physical component for coupling to a plug of an energy transfer system (e.g., a plug 402 of the energy transfer system 300 described herein) to enable an energy transfer from the energy transfer device to the energy storage system 102 (or vice versa). While the term “receptacles” are used herein, the one or more receptacles 206 may include plugs, ports, connectors, or any other type of physical energy transfer component.

As indicated above, FIGS. 2A-2B are provided as an example. Other examples may differ from what is described in connection with FIGS. 2A-2B.

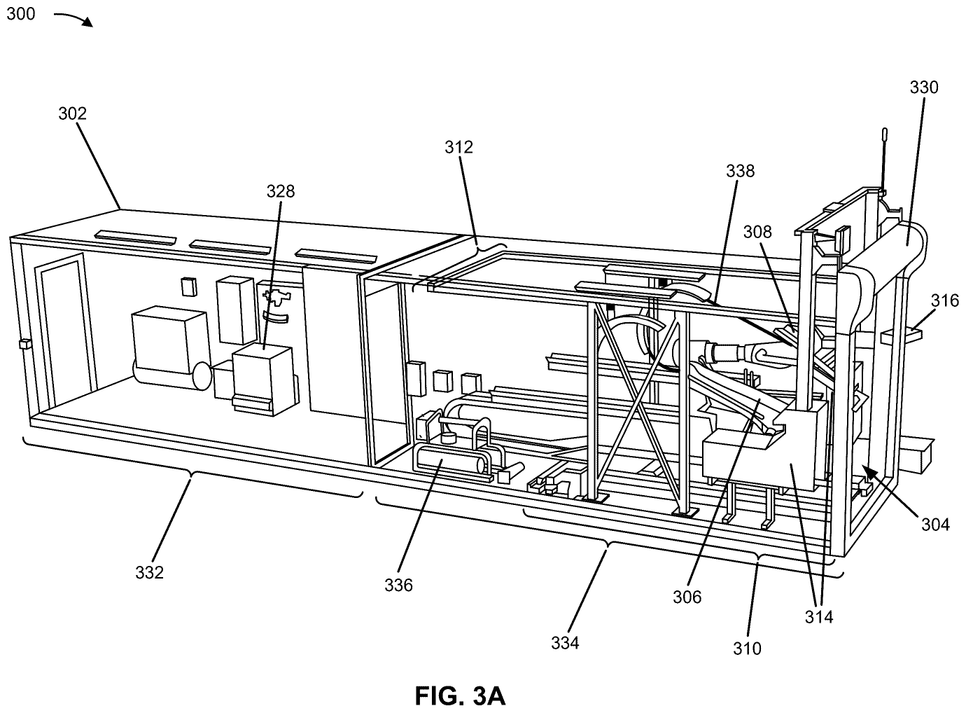

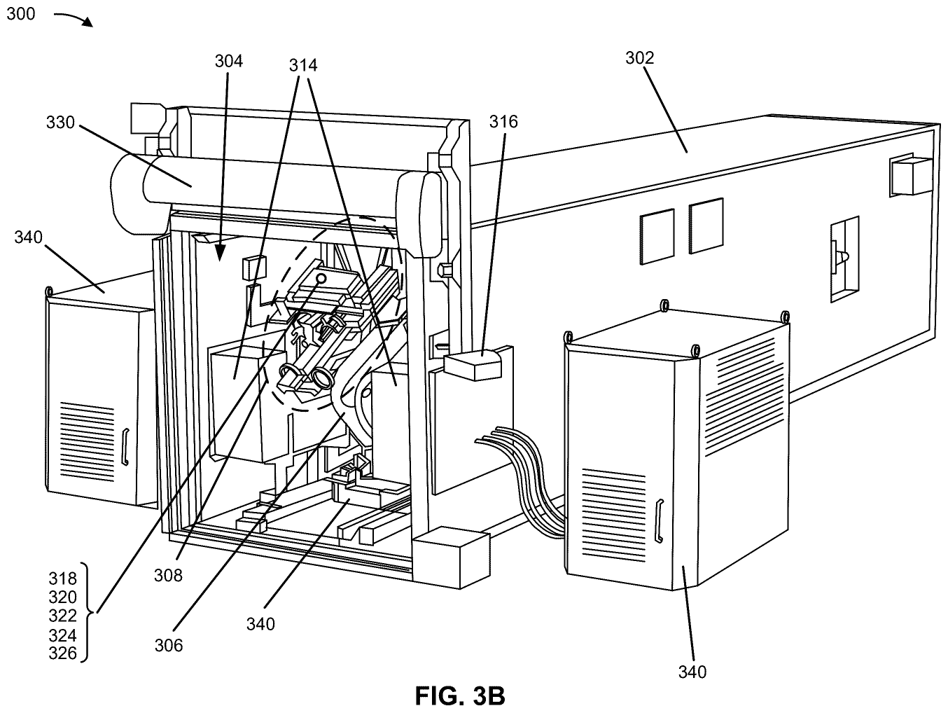

FIGS. 3A-3B are diagrams of an example energy transfer system 300. The energy transfer system 300 is configured to enable an energy transfer to and/or from the work machine 100 (e.g., to and/or from the energy storage system 102 of the work machine 100). In some implementations, the energy transfer system 300 is configured to autonomously enable the energy transfer (e.g., as further described herein), such as without any interaction with a human technician. However, other implementations include a human technician interacting with the energy transfer system 300 and, thus, the term “energy transfer system” includes any energy transfer system that is not autonomous, that is semi-autonomous (e.g., includes at least one autonomously controlled or operated system or component), or that is fully autonomous. FIG. 3A shows a side (cut-away) view of the energy transfer system 300, and FIG. 3B shows a front-angled view of the energy transfer system 300.

As shown in FIGS. 3A-3B, the energy transfer system 300 may include a housing 302 that includes a portal 304 at an end of the housing; a robotic system 306 that includes an end effector 308; a slide system 310; a cable management system 312; an energy transfer outlet system 314; a first camera system 316; a second camera system 318; a door opening system 320; a connector retention system 322; a connector protection system 324; a door closing system 326; and/or one or more controllers 328.

The housing 302 comprises a metal, or other hard and/or weather resistant material, and may have a rectangular prism shape. For example, the housing 302, may have a similar size and/or dimensions of a shipping container (e.g., with four “long” sides and two “short” sides). The housing 302 may include the portal 304 at an end of the housing 302 (e.g., instead of one of the short sides of the housing 302). The energy transfer system 300 may include an access door 330 that is configured to cover the portal 304 when closed, and to uncover the portal 304 when open. For example, the access door 330 may be a retractable door. The access door 330, when closed, may protect an interior of the housing 302, such by preventing dirt, rocks, construction debris, waste matter, moisture, or other material (e.g., present at a work site at which the work machine 100 is operating) from accessing interior of the housing 302.

As shown in FIG. 3A, the interior of the housing 302 may be divided into a first interior portion 332 of the housing 302 and a second interior portion 334 of the housing 302 (e.g., that is separated by a wall, a door, or another separator). The first interior portion 332 of the housing 302 may include the one or more controllers 328 and/or one or more other electrical components, one or more pneumatic components, and/or one or more other communication components, among other examples, that enable operation of the systems and components included in the second interior portion 334 of the housing 302.

The second interior portion 334 of the housing 302 may include the slide system 310, the cable management system 312, and the energy transfer outlet system 314. The second interior portion 334 may also include additional systems and/or components for enabling operation of the robotic system 306 and/or an energy transfer operation, such as a pressure washer system 336 and one or more energy transfer cables 338 (e.g., that are configured to transmit energy to and/or from one or more plugs of the end effector 308, such as the one or more plugs 402 described herein).

The slide system 310 is configured to move the robotic system 306, via the portal 304 of the housing 302, between an interior of the housing 302 (e.g., the second interior portion 334 of the housing 302) and an external environment (e.g., that surrounds the housing 302, such as at a work site). The cable management system 312 is configured to provide management of the one or more energy transfer cables 338. The energy transfer outlet system 314 is configured to enable a connection between the one or more energy transfer cables 338 and an external transfer dispenser system 340 (e.g., that is not included in the energy transfer system 300). Accordingly, the external transfer dispenser system 340 may provide energy to the one or more energy transfer cables 338, and thus to plugs of the end effector (e.g., the plugs 402 described herein) via the energy transfer outlet system 314.

As shown in FIGS. 3A-3B, the first camera system 316 may be mounted on an exterior (e.g., an exterior side) of the housing 302. The first camera system 316 is configured to obtain first image data associated with the receptacle access point 104 (e.g., when mounted on the work machine 100). For example, the first camera system 316 may obtain the first image data to allow the one or more controllers 328 to determine whether the receptacle access point 104 is within an engagement range of the robotic system 306 (e.g., when the robotic system 306 is moved to the external environment by the slide system 310), such as to allow the robotic system 306 to interact with the receptacle access point 104 to initiate an energy transfer operation.

As shown in FIG. 3A, the second interior portion 334 of the housing 302 may include the robotic system 306 (e.g., mounted to the slide system 310), such as when the robotic system 306 been moved to the interior of the housing 302 by the slide system 310. The robotic system 306 is configured to enable an energy transfer to or from the work machine 100 (e.g., to or from the energy storage system 102 of the work machine 100), such as when the robotic system 306 been moved to the external environment by the slide system 310.

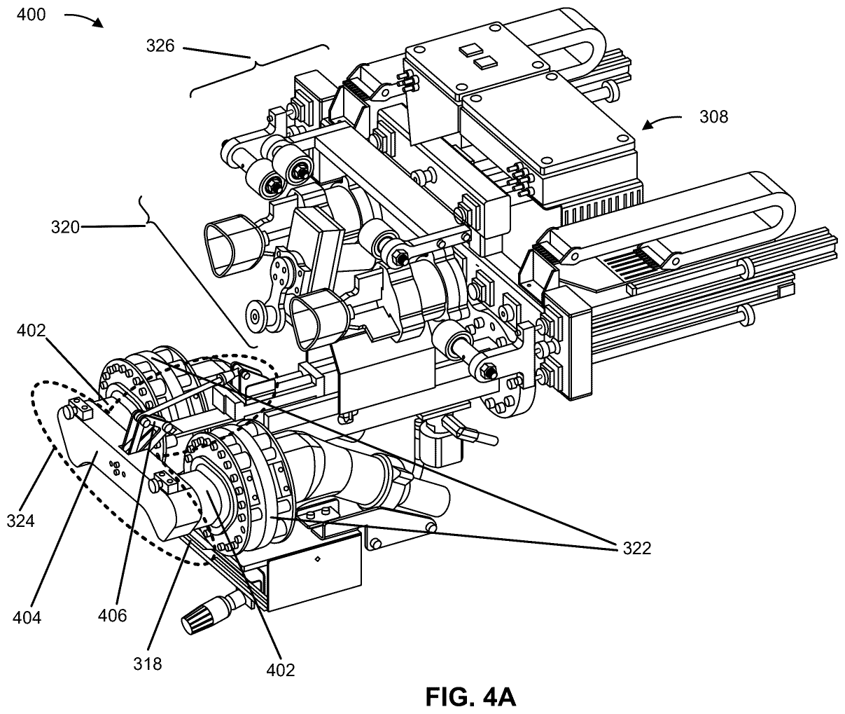

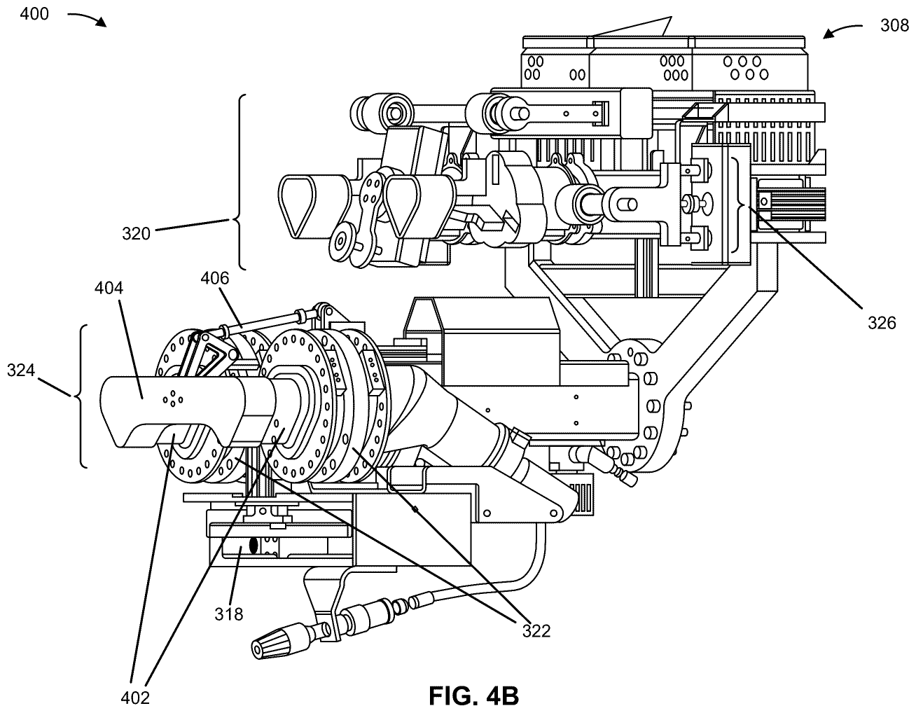

Accordingly, the robotic system includes the end effector 308, which may include (e.g., mounted to the end effector 308) the second camera system 318, the door opening system 320, the connector retention system 322, the connector protection system 324, and/or the door closing system 326. As the illustration of the end effector 308 is too small in FIGS. 3A-3B to clearly depict the second camera system 318, the door opening system 320, the connector retention system 322, the connector protection system 324, and/or the door closing system 326, these systems and the end effector 308 are shown in greater detail in FIGS. 4A-4B.

The second camera system 318 is configured to obtain second image data associated with the access mechanism 204 of the receptacle access point 104. For example, the second camera system 318 may obtain the second image data to allow the one or more controllers 328 to identify a location of the access mechanism 204 of the receptacle access point 104, such as to allow the door opening system 320 to open the access door 202 of the receptacle access point 104. Further, the second camera system 318 is configured to obtain third image data associated with the one or more receptacles 206 included in the receptacle access point 104, such as to allow the one or more controllers 328 to identify a location of the one or more receptacles 206 and therefore enable one or more plugs of the end effector 308 (e.g., the one or more plugs 402 of the end effector 308 further described herein) to couple to the one or more receptacles 206 and thereby enable the energy transfer operation.

The door opening system 320 is configured to open the access door 202 of the receptacle access point 104 (e.g., based on the location of the access mechanism 204 of the receptacle access point 104 identified by the one or more controllers 328). The door opening system 320 may include a manipulation system for manipulating the access mechanism 204 of the receptacle access point 104 to allow the access door 202 to open. The connector retention system 322 is configured to enable coupling between the one or more plugs of the end effector 308 (e.g., the one or more plugs 402 of the end effector 308 further described herein) and the one or more receptacles 206 (e.g., to enable the energy transfer operation).

The connector protection system 324 is configured to protect the one or more plugs of the end effector 308 (e.g., the one or more plugs 402 of the end effector 308 further described herein) when not coupled to the one or more receptacles 206. The connector protection system 324 may include a connector protection mechanism (e.g., the connector protection mechanism 404 described herein in relation to FIGS. 4A-4B) for covering the one or more plugs and an adjustment system (e.g., the adjustment system 406 described herein in relation to FIGS. 4A-4B) for removing the connector protection mechanism (e.g., from the one or more plugs) and for replacing the connector protection mechanism (e.g., on the one or more plugs).

The door closing system 326 is configured to close the access door 202 of the receptacle access point 104 (e.g., after cessation of an energy transfer operation enabled by coupling of the one or more receptacles 206 to one or more plugs of the end effector 308).

As indicated above, FIGS. 3A-3B are provided as an example. Other examples may differ from what is described in connection with FIGS. 3A-3B.

FIGS. 4A-4B are diagrams of examples 400 of the end effector 308 of the robotic system 306 described herein. FIG. 4A shows a side-angled view of the end effector 308, and FIG. 4B shows a front-angled view of the end effector 308.

As shown in FIGS. 4A-4B, the end effector 308 includes one or more plugs 402. Each of the one or more plugs 402 may be any type of physical component for coupling to a corresponding receptacle 206 of the receptacle access point 104 to enable an energy transfer from the energy transfer system 300 to the work machine 100 (e.g., to the energy storage system 102 of the work machine 100) (or vice versa). Accordingly, the energy transfer is to occur when the one or more plugs 402 are coupled to the one or more receptacles 206 of the receptacle access point 104. While the term “plugs” are used herein, the one or more plugs 402 may include receptacles, ports, connectors, or any other type of physical energy transfer component.

As further shown in FIGS. 4A-4B, the end effector 308 may include (e.g., mounted to the end effector 308) the second camera system 318, the door opening system 320, the connector retention system 322, the connector protection system 324, and/or the door closing system 326. For example, as shown in FIGS. 3A-3B, the second camera system 318 may be positioned at a bottom of the end effector 308, the one or more plugs 402 may be positioned above the second camera system 318 (and the connector retention system 322 and the connector protection system 324 may be positioned in line with the one or more plugs 402), the door opening system 320 may be positioned above the one or more plugs 402, and the door closing system 326 may be positioned above the door opening system 320.

As shown in FIGS. 4A-4B, the connector protection system 324 may include a connector protection mechanism 404 for covering the one or more plugs 402 when the one or more plugs 402 are not coupled to the one or more receptacles 206 of the receptacle access point 104 (e.g., when an energy transfer operation is not occurring). The connector protection mechanism 404 may include, for example, a cap, a cover, a lid, an enclosure, a covering, or another type connector protection mechanism. Additionally, the connector protection system 324 may include an adjustment system 406 (e.g., that is connected to the connector protection mechanism 404) for removing the connector protection mechanism 404 when the one or more plugs 402 are to couple to the one or more receptacles 206 and for replacing the connector protection mechanism 404 when the one or more plugs 402 are to uncouple from the one or more receptacles 206.

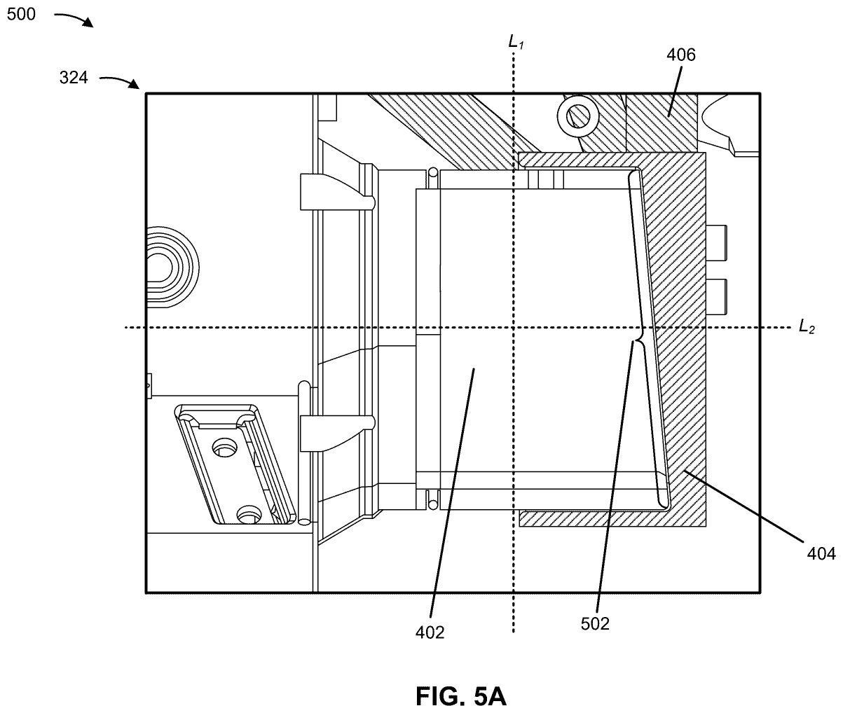

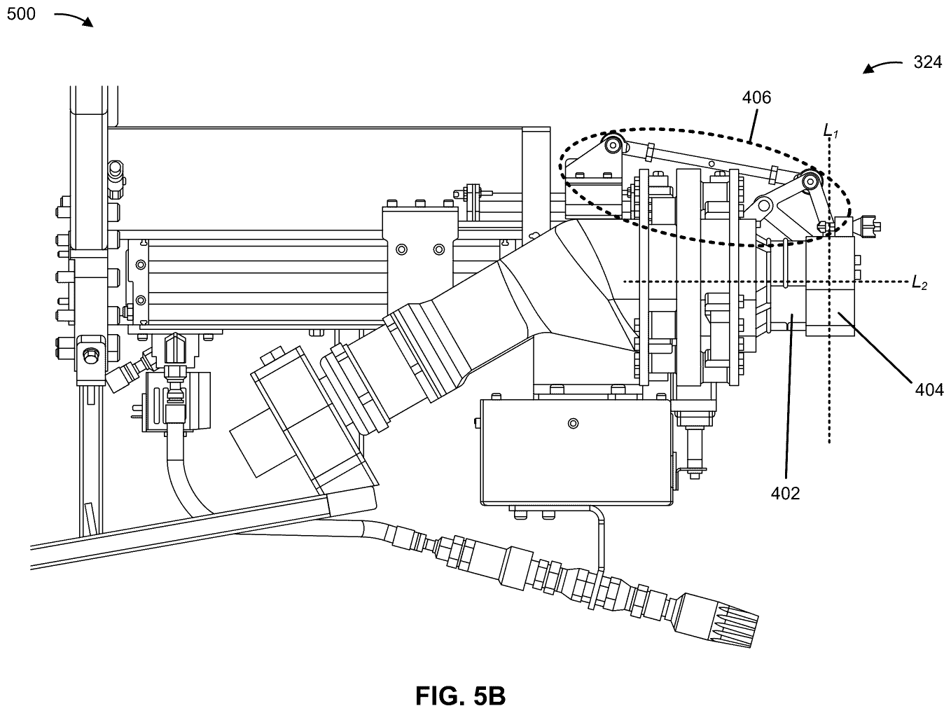

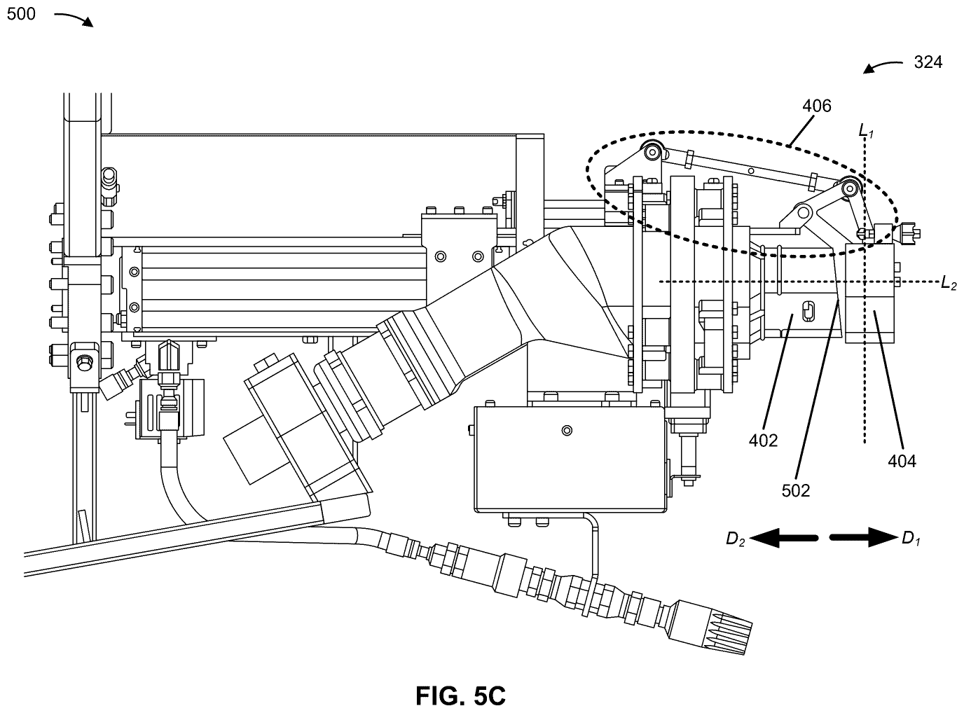

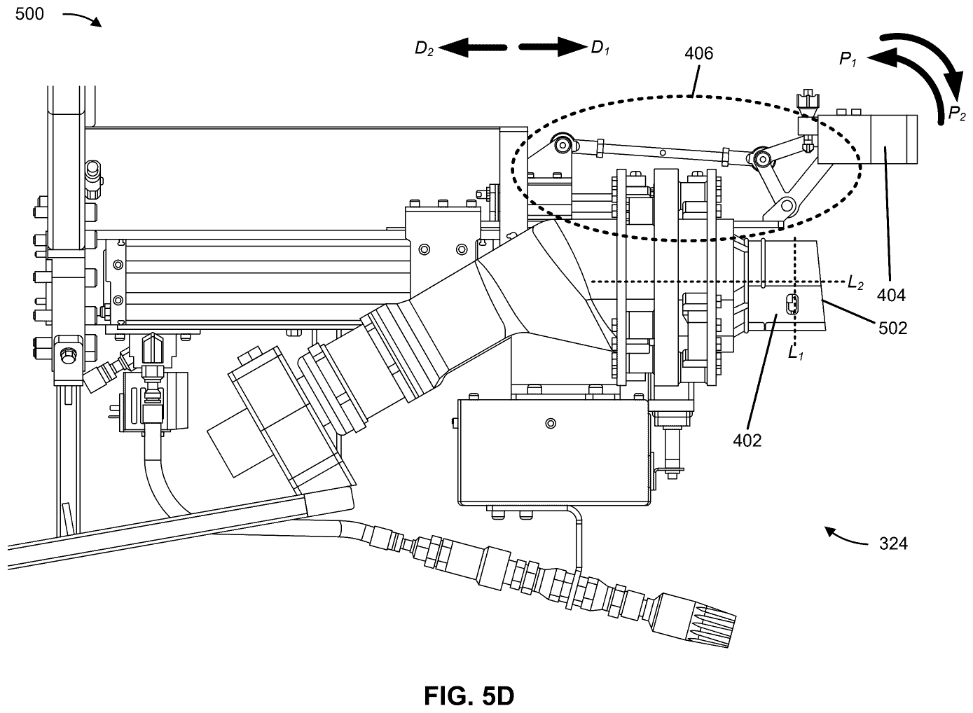

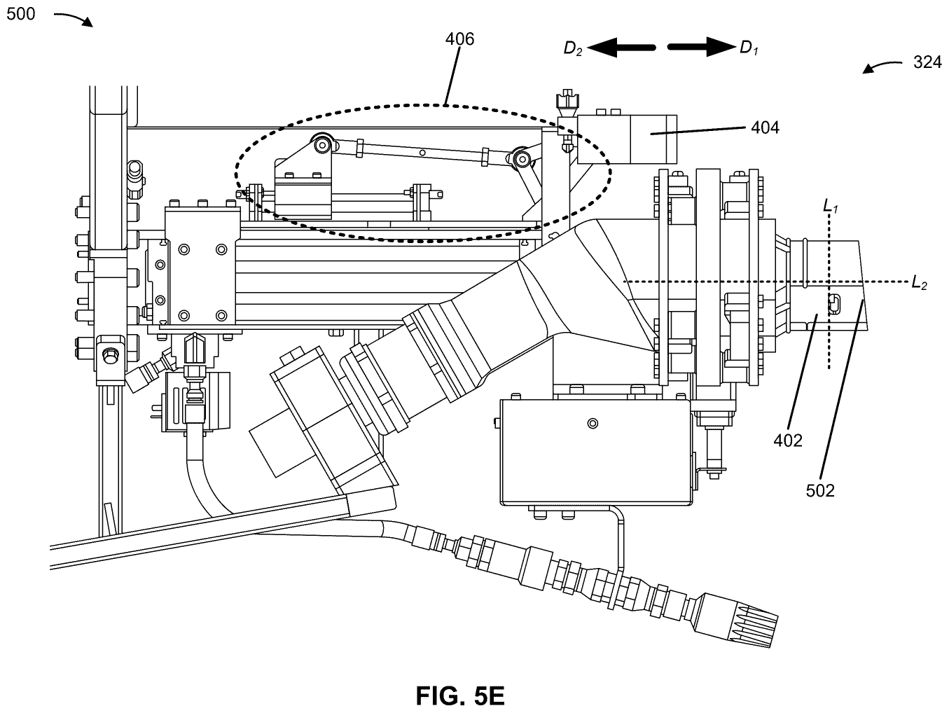

In some implementations, the adjustment system 406, to remove the connector protection mechanism 404, may be configured to remove the connector protection mechanism from the one or more plugs 402 and to cause the connector protection mechanism 404 to be positioned in a lateral orientation relative to respective insertion ends of the one or more plugs 402 (e.g., positioned to a “side” of the one or more plugs 402, as further described herein in relation to FIGS. 5A-5E). Further, the adjustment system 406, to replace the connector protection mechanism 404, may be configured to cause the connector protection mechanism 404 to be positioned over respective insertion ends of the one or more plugs 402 (e.g., as further described herein in relation to FIGS. 5A-5E)

Further details related to the connector protection mechanism 404 and the adjustment system 406 are described herein in relation to FIGS. 5A-5E.

As indicated above, FIGS. 4A-4B are provided as an example. Other examples may differ from what is described in connection with FIGS. 4A-4B.

FIGS. 5A-5E are diagrams of examples 500 associated with the connector protection system 324. FIG. 5A shows a side (cut-away) view of the connector protection mechanism 404 of the connector protection system 324 and the one or more plugs 402; FIG. 5B shows a side view of the of the connector protection system 324 in a first configuration; FIG. 5C shows a side view of the of the connector protection system 324 in a second configuration; FIG. 5D shows a side view of the of the connector protection system 324 in a third configuration; and FIG. 5E shows a side view of the of the connector protection system 324 in a fourth configuration.

FIG. 5A shows a side (cut-away) view of the connector protection mechanism 404 of the connector protection system 324 and the one or more plugs 402 when the connector protection mechanism 404 covers the one or more plugs 402. As shown in FIG. 5A, the connector protection mechanism 404, via a contact surface of the connector protection mechanism 404 (e.g., an “internal” surface of the connector protection mechanism 404), may contact respective insertion ends 502 of the one or more plugs 402 (e.g., an end of the one or more plugs 402 that is to couple to a corresponding end of the one or more receptacles 206). As further shown in FIG. 5A, the respective insertion ends 502 of the one or more plugs 402 may be angled (e.g., have a non-zero angle relative to a lateral axis L₁ of the one or more plugs 402, wherein the lateral axis L₁ is orthogonal to a longitudinal axis L₂ of the one or more plugs 402). Accordingly, the contact surface of the connector protection mechanism 404 may be similarly angled (e.g., may have the same non-zero angle, within a tolerance of 1 or 2 degrees) such that at least a portion of the contact surface of the connector protection mechanism 404 is flush with the respective insertion ends 502 of the one or more plugs 402 when the connector protection mechanism 404 covers the one or more plugs 402.

FIG. 5B shows a side view of the of the connector protection system 324 in a first configuration when the connector protection mechanism 404 covers the one or more plugs 402. As shown in FIG. 5B, the connector protection mechanism 404 is positioned over the respective insertion ends 502 of the one or more plugs 402.

To remove the connector protection mechanism 404 from the one or more plugs 402 (e.g., from the respective insertion ends 502 of the one or more plugs), the adjustment system 406 may move the connector protection mechanism 404 in a first direction D₁ that is parallel (e.g., within a tolerance of 1 or 2 degrees) to the longitudinal axis L₂ of the one or more plugs 402, such as to allow the contact surface of the connector protection mechanism 404 to cease contacting the respective insertion ends 502 of the one or more plugs 402. In this way, the adjustment system 406 may cause the connector protection mechanism 404 to be positioned proximate to, but not covering, the respective insertion ends 502 of the one or more plugs 402 (e.g., positioned in “front of”, but not contacting, the respective insertion ends 502 of the one or more plugs 402), such as shown in the second configuration of the connector protection system 324 (e.g., illustrated in FIG. 5C). Further, the adjustment system 406 may pivot the connector protection mechanism 404 in a first pivot direction P (e.g., shown as a counter-clockwise direction in FIG. 5D), such as at least 90 degrees. This may allow the connector protection mechanism 404 to cease being proximate to the one or more plugs 402 (e.g., to cease being positioned in front of the respective insertion ends 502 of the one or more plugs 402), such as shown in the third configuration of the connector protection system 324 (e.g., illustrated in FIG. 5D). Additionally, the adjustment system 406 may move the connector protection mechanism 404 in a second direction D₂ that is parallel (e.g., within a tolerance of 1 or 2 degrees) to the longitudinal axis L₂ of the one or more plugs 402 (and that is opposite the first direction D₁). In this way, the adjustment system 406 may cause the connector protection mechanism 404 to be positioned in a lateral orientation relative to the respective insertion ends 502 of the one or more plugs 402, such as shown in the fourth configuration of the connector protection system 324 (e.g., illustrated in FIG. 5E). That is, the connector protection mechanism 404 may be in an “uncovered” position, where the connector protection mechanism 404 is positioned to a “side” of the respective insertion ends 502 of the one or more plugs 402 and such that no portion of the connector protection mechanism 404 extends to the respective insertion ends 502 of the one or more plugs 402 in the first direction D₁. The connector protection mechanism 404, when in the lateral orientation relative to the respective insertion ends 502 of the one or more plugs 402, is therefore unable to physically interfere with a coupling of the one or more plugs 402 and the one or more receptacles 206.

To replace the connector protection mechanism 404 on the one or more plugs 402 (e.g., on the respective insertion ends 502 of the one or more plugs), the adjustment system 406, when the connector protection mechanism 404 is positioned in the lateral orientation relative to the respective insertion ends 502 of the one or more plugs 402, may move the connector protection mechanism 404 in the first direction D₁ (again). This may allow at least a portion of the connector protection mechanism 404 to extend, in the first direction D₁, to the respective insertion ends 502 of the one or more plugs 402, such as shown in the third configuration of the connector protection system 324 (e.g., illustrated in FIG. 5D). Further, the adjustment system 406 may pivot the connector protection mechanism 404 in a second pivot direction P₂ (e.g., that is the opposite the pivot direction P₁, shown as a clockwise direction in FIG. 5D), such as at least 90 degrees. In this way, the adjustment system 406 may cause the connector protection mechanism 404 to be positioned proximate to, but not covering, the respective insertion ends 502 of the one or more plugs 402 (e.g., positioned in front of, but not contacting, the respective insertion ends 502 of the one or more plugs 402), such as shown in the second configuration of the connector protection system 324 (e.g., illustrated in FIG. 5C). Additionally, the adjustment system 406 may move the connector protection mechanism 404 in the second direction D₂ (again) (e.g., that is opposite the first direction D₁). This may allow the contact surface of the connector protection mechanism 404 to contact the respective insertion ends 502 of the one or more plugs 402, such as shown in the first configuration of the connector protection system 324 (e.g., illustrated in FIG. 5B).

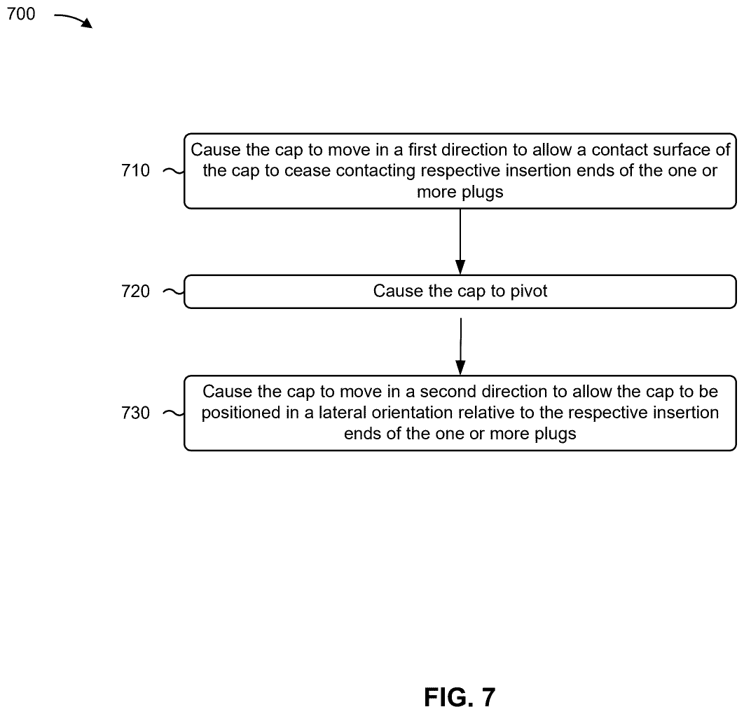

The adjustment system 406 may control the connector protection mechanism 404 and/or the adjustment system 406, as further described herein in relation to FIG. 7.

As indicated above, FIGS. 5A-5E are provided as an example. Other examples may differ from what is described in connection with FIGS. 5A-5E.

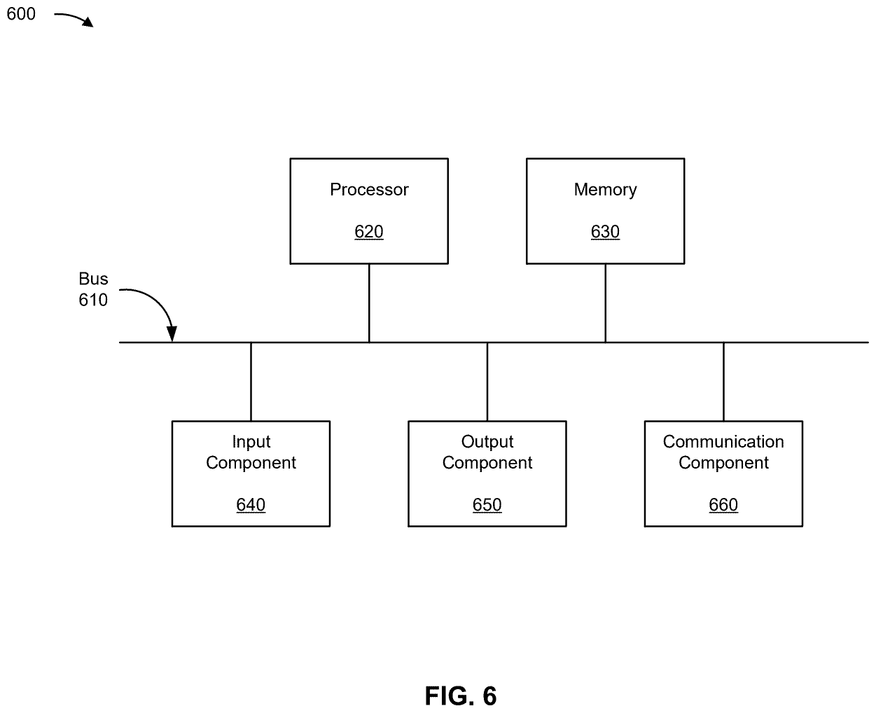

FIG. 6 is a diagram of example components of a device 600 associated with a connector protection system of an energy transfer system. The device 600 may correspond to the one or more controllers 328 and/or one or more other components of the energy transfer system 300. The one or more controllers 328 and/or one or more other components of the energy transfer system 300 may include one or more devices 600 and/or one or more components of the device 600. As shown in FIG. 6, the device 600 may include a bus 610, a processor 620, a memory 630, an input component 640, an output component 650, and/or a communication component 660.

The bus 610 may include one or more components that enable wired and/or wireless communication among the components of the device 600. The bus 610 may couple together two or more components of FIG. 6, such as via operative coupling, communicative coupling, electronic coupling, and/or electric coupling. For example, the bus 610 may include an electrical connection (e.g., a wire, a trace, and/or a lead) and/or a wireless bus. The processor 620 may include a central processing unit, a graphics processing unit, a microprocessor, a controller, a microcontroller, a digital signal processor, a field-programmable gate array, an application-specific integrated circuit, and/or another type of processing component. The processor 620 may be implemented in hardware, firmware, or a combination of hardware and software. The processor 620 may include one or more processors capable of being programmed to perform one or more operations or processes described elsewhere herein.

The memory 630 may include volatile and/or nonvolatile memory. For example, the memory 630 may include random access memory (RAM), read only memory (ROM), a hard disk drive, and/or another type of memory (e.g., a flash memory, a magnetic memory, and/or an optical memory). The memory 630 may include internal memory (e.g., RAM, ROM, or a hard disk drive) and/or removable memory (e.g., removable via a universal serial bus connection). The memory 630 may be a non-transitory computer-readable medium. The memory 630 may store information, one or more instructions, and/or software (e.g., one or more software applications) related to the operation of the device 600. The memory 630 may include one or more memories that are coupled (e.g., communicatively coupled) to one or more processors (e.g., processor 620), such as via the bus 610. Communicative coupling between a processor 620 and a memory 630 may enable the processor 620 to read and/or process information stored in the memory 630 and/or to store information in the memory 630.

The input component 640 may enable the device 600 to receive input, such as user input and/or sensed input. For example, the input component 640 may include a touch screen, a keyboard, a keypad, a mouse, a button, a microphone, a switch, a sensor, a global positioning system sensor, an accelerometer, a gyroscope, and/or an actuator. The output component 650 may enable the device 600 to provide output, such as via a display, a speaker, and/or a light-emitting diode. The communication component 660 may enable the device 600 to communicate with other devices via a wired connection and/or a wireless connection. For example, the communication component 660 may include a receiver, a transmitter, a transceiver, a modem, a network interface card, and/or an antenna.

The device 600 may perform one or more operations or processes described herein. For example, a non-transitory computer-readable medium (e.g., memory 630) may store a set of instructions (e.g., one or more instructions or code) for execution by the processor 620. The processor 620 may execute the set of instructions to perform one or more operations or processes described herein. Execution of the set of instructions, by one or more processors 620, causes the one or more processors 620 and/or the device 600 to perform one or more operations or processes described herein. Hardwired circuitry may be used instead of or in combination with the instructions to perform one or more operations or processes described herein. Additionally, or alternatively, the processor 620 may be configured to perform one or more operations or processes described herein. Thus, implementations described herein are not limited to any specific combination of hardware circuitry and software.

The number and arrangement of components shown in FIG. 6 are provided as an example. The device 600 may include additional components, fewer components, different components, or differently arranged components than those shown in FIG. 6. Additionally, or alternatively, a set of components (e.g., one or more components) of the device 600 may perform one or more functions described as being performed by another set of components of the device 600.

FIG. 7 is a flowchart of an example process 700 associated with a connector protection system (e.g., the connector protection system 324) of an energy transfer system (e.g., the energy transfer system 300). The connector protection system may include a connector protection mechanism (e.g., the connector protection mechanism 404) and an adjustment system (e.g., the adjustment system 406). The energy transfer system may include a robotic system (e.g., the robotic system 306) with an end effector (e.g., the end effector 308) that includes one or more plugs (e.g., the one or more plugs 402). One or more process blocks of FIG. 7 may be performed by one or more controllers (e.g., the one or more controllers 328) of the energy transfer system. One or more process blocks of FIG. 7 may be performed by another device or a group of devices separate from or including the one or more controllers, such as one or more other components of the energy transfer system. Additionally, or alternatively, one or more process blocks of FIG. 7 may be performed by one or more components of device 600, such as processor 620, memory 630, input component 640, output component 650, and/or communication component 660.

As shown in FIG. 7, process 700 may include causing the connector protection mechanism to move in a first direction to allow a contact surface of the connector protection mechanism to cease contacting respective insertion ends of the one or more plugs (block 710). For example, the one or more controllers may cause, when the connector protection mechanism covers the one or more plugs and using the adjustment system, the connector protection mechanism to move in a first direction (e.g., the first direction D₁) to allow a contact surface of the connector protection mechanism to cease contacting respective insertion ends (e.g., the respective insertion ends 502) of the one or more plugs. The first direction may be parallel to a longitudinal axis (e.g., the longitudinal axis L₂) of the one or more plugs. This may cause the connector protection mechanism to be proximate to (e.g., in front of), but not covering, the respective insertion ends of the one or more plugs.

As further shown in FIG. 7, process 700 may include causing the connector protection mechanism to pivot (block 720). For example, the one or more controllers, using the adjustment system and based on causing the connector protection mechanism to move in the first direction, may cause the connector protection mechanism to pivot. This may allow the connector protection mechanism to cease being proximate to the respective insertion ends of the one or more plugs.

As further shown in FIG. 7, process 700 may include causing the connector protection mechanism to move in a second direction to allow the contact surface of the connector protection mechanism to be positioned in a lateral orientation relative to the respective insertion ends of the one or more plugs (block 730). For example, the one or more controllers may cause, using the adjustment system and based on causing the connector protection mechanism to pivot, the connector protection mechanism to move in a second direction (e.g., the second direction D₂) to allow the connector protection mechanism to be positioned in a lateral orientation relative to the respective insertion ends of the one or more plugs (e.g., such that no portion of the connector protection mechanism extends to the respective insertion ends of the one or more plugs in the first direction). The second direction may be opposite the first direction.

In some implementations, process 700 may include causing, when the connector protection mechanism is positioned in the lateral orientation relative to the respective insertion ends of the one or more plugs and using the adjustment system, the connector protection mechanism to move in the first direction (again) to allow at least a portion of the connector protection mechanism to extend, in the first direction, to the respective insertion ends of the one or more plugs; causing, using the adjustment system and based on causing the connector protection mechanism to move in the first direction (again), the connector protection mechanism to pivot (e.g., in a second pivot direction) to allow the contact surface to be positioned proximate to the respective insertion ends of the one or more plugs; and causing, using the adjustment system and based on causing the connector protection mechanism to pivot, the connector protection mechanism to move the connector protection mechanism in the second direction (again) to allow the contact surface of the connector protection mechanism to contact the respective insertion ends of the one or more plugs.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

### Industrial Applicability

The disclosed connector protection system protects one or more plugs of an energy transfer system when the one or more plugs are not being used to facilitate an energy transfer (e.g., for a work machine). For example, the connector protection system protects the one or more plugs when the one or more plugs are not coupled to one or more receptacles of a receptacle access point of the work machine.

The connector protection system may include a connector protection mechanism for covering the one or more plugs and an adjustment system for removing the connector protection mechanism (e.g., from the one or more plugs) and for replacing the connector protection mechanism (e.g., on the one or more plugs). The connector protection mechanism is configured to contact, via a contact surface of the connector protection mechanism, respective insertion ends of the one or more plugs when the connector protection mechanism covers the one or more plugs. To remove the connector protection mechanism, the adjustment system causes (e.g., by moving and pivoting the connector protection mechanism) the connector protection mechanism to be positioned in a lateral orientation relative to the respective insertion ends of the one or more plugs. That is, the adjustment system moves the connector protection mechanism to an uncovered position, where the connector protection mechanism is positioned to a side of the respective insertion ends of the one or more plugs and such that no portion of the connector protection mechanism extends to the respective insertion ends of the one or more plugs. The connector protection mechanism is therefore unable to physically interfere with a coupling of the one or more plugs and the one or more receptacles (e.g., to enable an energy transfer). To replace the connector protection mechanism on the one or more plugs (e.g., on the respective insertion ends of the one or more plugs), such as after cessation of the energy transfer, the adjustment system causes (e.g., by moving and pivoting the connector protection mechanism) the contact surface of the connector protection mechanism to contact the respective insertion ends of the one or more plugs. That is, the connector protection mechanism system moves the connector protection mechanism to a covered position on the one or more plugs, which protects the one or more plugs.

In this way, the disclosed connector protection system protects the one or more plugs of the energy transfer system, when not being utilized for an energy transfer, from exposure to environmental conditions (e.g., that include rain, snow, dirt, debris, among other examples) and potential contact damage at a work site. This can minimize, or eliminate, physical degradation of the one or more plugs (e.g., over an operable lifetime of the one or more plugs), which improves a capability of the one or more plugs to facilitate an optimal energy transfer.

This increase a likelihood of an optimal replenishment of an energy storage system of a work machine, such as in terms of decreasing an amount of time needed to replenish the energy storage system and in terms of enabling an increased replenishment level of the energy storage system (e.g., at, or near, a maximum replenishment level of the energy storage system). Optimal replenishment improves a performance of the work machine, such as by increasing an amount of time that the work machine is available to perform powered operations (e.g., as compared to an amount of time that the work machine needs to be replenished) and by increasing an amount of power that is available to perform the powered operations. Optimal replenishment of the machine also prevents, or minimizes a likelihood of, degradation of the energy storage system of the work machine, which improves a performance and/or operable life of the energy storage system, and the work machine.

What is claimed is:

1. An energy transfer system comprising:
a robotic system that includes an end effector for enabling an energy transfer to a work machine via a receptacle access point of the work machine,
wherein the energy transfer is to occur when one or more plugs of the end effector are coupled to one or more receptacles included in the receptacle access point; and
a connector protection system mounted on the end effector of the robotic system for protecting the one or more plugs of the end effector when the one or more plugs are not coupled to the one or more receptacles, wherein:
the connector protection system includes a connector protection mechanism for covering the one or more plugs.

2. The energy transfer system of claim 1, wherein:
the connector protection mechanism is connected to an adjustment system of the connector protection system; and
the connector protection mechanism is configured to contact, via a contact surface of the connector protection mechanism, respective insertion ends of the one or more plugs when the connector protection mechanism covers the one or more plugs.

3. The energy transfer system of claim 1, wherein the connector protection system includes an adjustment system for removing the connector protection mechanism,
wherein the adjustment system, to remove the connector protection mechanism, is configured to remove the connector protection mechanism from the one or more plugs and to cause the connector protection mechanism to be positioned in a lateral orientation relative to respective insertion ends of the one or more plugs.

4. The energy transfer system of claim 1, wherein the connector protection system includes an adjustment system for removing the connector protection mechanism,
wherein the adjustment system, to remove the connector protection mechanism, is configured to:
move the connector protection mechanism in a first direction that is parallel to a longitudinal axis of the one or more plugs to allow a contact surface of the connector protection mechanism to cease contacting respective insertion ends of the one or more plugs, such that the connector protection mechanism is proximate to, but not covering, the respective insertion ends of the one or more plugs;
pivot the connector protection mechanism to allow the connector protection mechanism to cease being proximate to the respective insertion ends of the one or more plugs; and
move the connector protection mechanism in a second direction, that is opposite the first direction, to allow the connector protection mechanism to be positioned in a lateral orientation relative to the respective insertion ends of the one or more plugs.

5. The energy transfer system of claim 1, wherein the connector protection system includes an adjustment system for replacing the connector protection mechanism,
wherein the adjustment system, to replace the connector protection mechanism, is configured to cause the connector protection mechanism to be positioned such that a contact surface of the connector protection mechanism is in front of respective insertion ends of the one or more plugs and to cause the contact surface of the connector protection mechanism to contact the respective insertion ends of the one or more plugs.

6. The energy transfer system of claim 1, further comprising one or more controllers configured to:
cause, when the connector protection mechanism covers the one or more plugs and using an adjustment system of the connector protection system, the connector protection mechanism to move in a first direction that is parallel to a longitudinal axis of the one or more plugs, to allow a contact surface of the connector protection mechanism to cease contacting respective insertion ends of the one or more plugs;
cause, using the adjustment system and based on causing the connector protection mechanism to move in the first direction, the connector protection mechanism to pivot at least 90 degrees; and
cause, using the adjustment system and based on causing the connector protection mechanism to pivot, the connector protection mechanism to move in a second direction, that is opposite the first direction, to allow the connector protection mechanism to be positioned in a lateral orientation relative to the respective insertion ends of the one or more plugs.

7. The energy transfer system of claim 1, further comprising one or more controllers configured to:
cause, when the connector protection mechanism is positioned in a lateral orientation relative to respective insertion ends of the one or more plugs and using an adjustment system of the connector protection system, the connector protection mechanism to move in a first direction that is parallel to a longitudinal axis of the one or more plugs, to allow at least a portion of the connector protection mechanism to extend, in the first direction, to the respective insertion ends of the one or more plugs;
cause, using the adjustment system and based on causing the connector protection mechanism to move in the first direction, the connector protection mechanism to pivot at least 90 degrees to allow a contact surface to be positioned proximate to the respective insertion ends of the one or more plugs; and
cause, using the adjustment system and based on causing the connector protection mechanism to pivot, the connector protection mechanism to move in a second direction, that is opposite the first direction, to allow the contact surface of the connector protection mechanism to contact the respective insertion ends of the one or more plugs.

8. An end effector of a robotic system, comprising:
a connector protection system for protecting one or more plugs of the end effector when not coupled to one or more receptacles included in a receptacle access point,
wherein the connector protection system includes a connector protection mechanism for covering the one or more plugs, and
wherein the connector protection system includes an adjustment system for removing and replacing the connector protection mechanism.

9. The end effector of the robotic system of claim 8, wherein the connector protection mechanism is configured to:
contact surface of the connector protection mechanism, respective insertion ends of the one or more plugs, when the connector protection mechanism is covering the one or more plugs; and
configured to be positioned in a lateral orientation relative to the respective insertion ends of the one or more plugs, when the connector protection mechanism is not covering the one or more plugs.

10. The end effector of the robotic system of claim 8, wherein the adjustment system is configured to remove the connector protection mechanism from the one or more plugs such that the connector protection mechanism is positioned in a lateral orientation relative to respective insertion ends of the one or more plugs.

11. The end effector of the robotic system of claim 8, wherein the adjustment system is configured to cause the connector protection mechanism to be positioned such that a contact surface of the connector protection mechanism is positioned in front of respective insertion ends of the one or more plugs and to cause the contact surface of the connector protection mechanism to contact the respective insertion ends of the one or more plugs.

12. The end effector of the robotic system of claim 8, wherein the connector protection mechanism is configured to:
contact respective insertion ends of the one or more plugs, when the connector protection mechanism is in a covered position; and
be positioned such that no portion of the connector protection mechanism extends to the respective insertion ends of the one or more plugs in a direction that is parallel to a longitudinal axis of the one or more plugs, when the connector protection mechanism is in an uncovered position.

13. The end effector of the robotic system of claim 8, wherein the adjustment system, to remove the connector protection mechanism, is configured to:
move the connector protection mechanism in a first direction that is parallel to a longitudinal axis of the one or more plugs;
pivot, based on moving the connector protection mechanism in the first direction, the connector protection mechanism in a first pivot direction; and
move, based on pivoting the connector protection mechanism in the first pivot direction, the connector protection mechanism in a second direction that is opposite the first direction.

14. The end effector of the robotic system of claim 13, wherein moving the connector protection mechanism in the second direction allows the connector protection mechanism to be positioned in a lateral orientation relative to respective insertion ends of the one or more plugs.

15. The end effector of the robotic system of claim 13, wherein the adjustment system, to replace the connector protection mechanism, is configured to:
move the connector protection mechanism in the first direction;
pivot, based on moving the connector protection mechanism in the first direction, the connector protection mechanism in a second pivot direction; and
move, based on pivoting the connector protection mechanism in the second pivot direction, the connector protection mechanism in the second direction.

16. The end effector of the robotic system of claim 15, wherein moving the connector protection mechanism in the second direction allows a contact surface of the connector protection mechanism to contact respective insertion ends of the one or more plugs.

17. A connector protection system of an end effector of a robotic system, comprising:
a connector protection mechanism for covering one or more plugs of the end effector when the one or more plugs are not coupled to one or more receptacles included in a receptacle access point; and
an adjustment system for removing and replacing the connector protection mechanism.

18. The connector protection system of claim 17, wherein the adjustment system is configured to cause a contact surface of the connector protection mechanism to contact respective insertion ends of the one or more plugs.

19. The connector protection system of claim 17, wherein the adjustment system is configured to cause the connector protection mechanism to be positioned in a lateral orientation relative to respective insertion ends of the one or more plugs.

20. The connector protection system of claim 17, wherein the connector protection mechanism is configured to:
contact respective insertion ends of the one or more plugs, when the connector protection mechanism is in a covered position; and
be positioned such that no portion of the connector protection mechanism extends to the respective insertion ends of the one or more plugs in a direction that is parallel to a longitudinal axis of the one or more plugs, when the connector protection mechanism is an uncovered position.
